(19) United States
(12) Patent Application Publication
(10) Pub. No.: US 2016/0277980 A1
(43) Pub. Date: Sep. 22, 2016

(54) Handing Over a Data Bearer Between Access Networks

(71) Applicant: TELEFONAKTIEBOLAGET L M ERICSSON (PUBL), Stockholm (SE)

(72) Inventors: Dinand Roeland, Sollentuna (SE); Stefan Rommer, Västra Frölunda (SE); Jari Vikberg, Järna (SE)

(73) Assignee: TELEFONAKTIEBOLAGET L M ERICSSON (PUBL), Stockholm (SE)

(21) Appl. No.: 14/410,849

(22) PCT Filed: Nov. 7, 2014
(86) PCT No.: PCT/SE2014/051327

§ 371 Date: Dec. 23, 2014

(51) Int. Cl. H04W 36/00; H04W 28/02; H04W 48/18; H04W 36/14

(52) U.S. Cl. CPC H04W 36/0066; H04W 36/14; H04W 28/0252; H04W 48/18; H04W 88/06

(57) ABSTRACT

It is presented a method for handing over a data bearer for traffic of an IFOM packet data connection between a packet data network and a mobile terminal from one access network to another access network. The method is performed in a packet data network gateway, and comprises the steps of: receiving a handover message, the handover message comprising a request to handover a source data bearer for the mobile terminal from a first access network to a second access network, wherein the first access network is a 3GPP network and the second access network is a non-3GPP network, or vice versa; transmitting a first routing rule; applying the first routing rule for downlink traffic; and establishing, when there is no matching data bearer, a new data bearer over the second access network, the new data bearer having a second routing rule matching the first routing rule.

### TECHNICAL FIELD

The invention relates to handovers and more particularly to handing over a data bearer from one access network to another access network.

### BACKGROUND

Cellular networks have evolved from being primarily a voice service to more and more a data service. With the proliferation of devices that have support for both Wireless Local Area Networks (WLAN) and cellular networks such as 3GPP (Third Generation Partnership Project) networks, moving traffic between 3GPP and non-3GPP networks, such as WLAN, is gaining increased interest both from user and operator perspectives.

There are a number of initiatives in this field, one of them being a 3GPP initiative for IP Flow Mobility (IFOM) as described in the technical specifications 3GPP TS 23.402 and 3GPP TS 23.261. Using IFOM, IP flows can be moved between WLAN and 3GPP networks. Moreover, IP address preservation and session continuity is provided when moving IP flows from one access network to another access network. In IFOM, an IP flow can thus be handed over from one access network to another access network.

However, it would be of great benefit if handover from one access network to another access network could be made more flexible without limiting current options.

### SUMMARY

It is an object to provide a more flexibility in handover from one access network to another access network, by enabling handover of traffic of a data bearer.

According to a first aspect, it is presented a method for handing over a data bearer for traffic of an IFOM, IP Flow Mobility, packet data connection between a packet data network and a mobile terminal from one access network to another access network. The method is performed in a packet data network gateway, and comprises the steps of: receiving a handover message from a radio access network controller, the handover message comprising a request to handover a source data bearer for the mobile terminal from a first access network to a second access network, wherein the first access network is a 3rd Generation Partnership Program, 3GPP, network and the second access network is a non-3GPP network, or vice versa; transmitting a first routing rule to the mobile terminal, the first routing rule mapping all traffic flows of the source data bearer to the second access network; applying the first routing rule for downlink traffic; determining when there is no matching data bearer over the second access network to the mobile terminal, matching the first routing rule; and establishing, when there is no matching data bearer, a new data bearer over the second access network, the new data bearer having a second routing rule matching the first routing rule.

The method may further comprise the step of: transmitting, when a new data bearer is established, an identifier of the new data bearer to the radio access network controller.

The step of transmitting the identifier may also comprise transmitting an identifier of the source data bearer.

The method may further comprise the steps of: determining whether to tear down the source data bearer; and tearing down the source data bearer when it is determined to do so.

The step of determining whether to tear down the source data bearer may comprise determining not to tear down the source data bearer when the source data bearer is a default bearer for the first access network.

The non-3GPP network may be a wireless local area network.

The first routing rule and the second routing rule may each be defined using a traffic flow template.

In one embodiment, the step of applying the first routing rule is only performed after receiving an acknowledgement from the mobile terminal that it will apply the first routing rule.

The step of determining when there is no matching data bearer may comprise determining a match only when a current routing rule of a data bearer of the second access network comprises IP fillers and a quality of service profile which matches the first routing rule.

According to a second aspect, it is presented a packet data network gateway arranged to hand over a data bearer for traffic of an IFOM, IP Flow Mobility, packet data connection between a packet data network and a mobile terminal from one access network to another access network. The packet data network gateway comprises: a processor; and a memory storing instructions that, when executed by the processor, causes the packet data network gateway to: receive a handover message from a radio access network controller, the handover message comprising a request to handover a source data bearer for the mobile terminal from a first access network to a second access network, wherein the first access network is a 3^{rd} Generation Partnership Program, 3GPP, network and the second access network is a non-3GPP network, or vice versa; transmit a first routing rule to the mobile terminal, the first routing rule mapping all traffic flows of the source data bearer to the second access network; apply the first routing rule for downlink traffic; determine when there is no matching data bearer over the second access network to the mobile terminal, matching the first routing rule; and establish, when there is no matching data bearer, a new data bearer over the second access network, the new data bearer having a second routing rule matching the first routing rule.

The instructions may further comprise instructions that, when executed by the processor, causes the packet data network gateway to transmit, when a new data bearer is established, an identifier of the new data bearer to the radio access network controller.

The instructions to transmit the identifier may also comprise instructions that, when executed by the processor, causes the packet data network gateway to transmit an identifier of the source data bearer.

The instructions may further comprise instructions that, when executed by the processor, causes the packet data network gateway to: determine whether to tear down the source data bearer; and tearing down the source data bearer when it is determined to do so.

The instructions to determine whether to tear down the source data bearer may comprise instructions that, when executed by the processor, causes the packet data network gateway to determine not to tear down the source data bearer when the source data bearer is a default bearer for the first access network.

The non-3GPP network may be a wireless local area network.

The first routing rule and the second routing rule may each be defined using a traffic flow template.

The instructions may further comprise instructions that, when executed by the processor, causes the packet data network gateway to apply the first routing rule only after receiving an acknowledgement from the mobile terminal that it will apply the first routing rule.

The instructions to determine when there is no matching data bearer may comprise instructions that, when executed by the processor, causes the packet data network gateway to determine a match only when a current routing rule of a data bearer of the second access network comprises IP filters and a quality of service profile which matches the first routing rule.

According to a third aspect, it is presented a packet data network gateway comprising: means for receiving a handover message from a radio access network controller, the handover message comprising a request to handover a source data bearer for a mobile terminal from a first access network to a second access network, wherein the first access network is a 3^{rd} Generation Partnership Program, 3GPP, network and the second access network is a non-3GPP network, or vice versa, the handover relating to traffic of an IFOM, IP Flow Mobility, packet data connection between a packet data network and the mobile terminal; means for transmitting a first routing rule to the mobile terminal, the first routing rule mapping all traffic flows of the source data bearer to the second access network; means for applying the first routing rule for downlink traffic; means for determining when there is no matching data bearer over the second access network to the mobile terminal, matching the first routing rule; and means for establishing, when there is no matching data bearer, a new data bearer over the second access network, the new data bearer having a second routing rule matching the first routing rule.

According to a fourth aspect, it is presented a computer program for handing over a data bearer for traffic of an IFOM, IP Flow Mobility, packet data connection between a packet data network and a mobile terminal from one access network to another access network. The computer program comprises computer program code which, when run on a packet data network gateway causes the packet data network gateway to: receive a handover message from a radio access network controller, the handover message comprising a request to handover a source data bearer for the mobile terminal from a first access network to a second access network, wherein the first access network is a 3^{rd} Generation Partnership Program, 3GPP, network and the second access network is a non-3GPP network, or vice versa; transmit a first routing rule to the mobile terminal, the first routing rule mapping all traffic flows of the source data bearer to the second access network; apply the first routing rule for downlink traffic; determine when there is no matching data bearer over the second access network to the mobile terminal, matching the first routing rule; and establish, when there is no matching data bearer, a new data bearer over the second access network, the new data bearer having a second routing rule matching the first routing rule.

According to a fifth aspect, it is presented a computer program product comprising a computer program according to the fourth aspect and a computer readable means on which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 is a schematic diagram illustrating an exemplifying wireless communication system in which embodiments presented herein can be implemented;

FIG. 2 is an entity relationship diagram illustrating relations for data connections in the system of FIG. 1;

FIG. 3 is a sequence diagram illustrating handover of a data bearer in the wireless communication system of FIG. 1 according to one embodiment;

FIG. 4 is a schematic diagram showing some components of the PGW of FIG. 1 according to one embodiment;

FIGS. 5A-B are flow charts illustrating embodiments of methods performed in the PGW of FIG. 1 for handover of a data bearer;

FIG. 6 is a schematic diagram showing functional modules of the PGW of FIG. 4 according to one embodiment; and

FIG. 7 shows one example of a computer program product comprising computer readable means.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

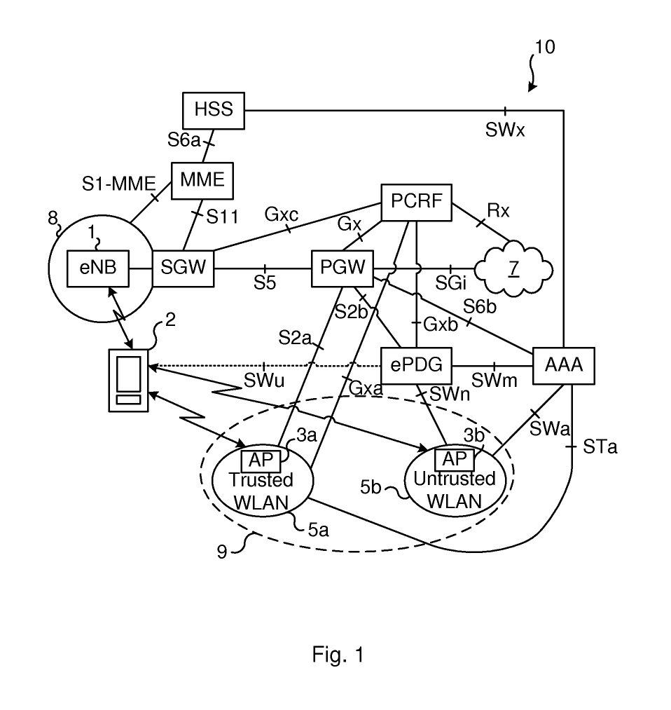

FIG. 1 is a schematic diagram illustrating an exemplifying wireless communication system in which embodiments presented herein can be implemented. The wireless communication system 10 is an LTE based system. It should be pointed out that the terms “LTE” and “LTE based” system used here should be construed to comprise both present and future LTE based systems, such as, for example, advanced LTE systems. It should be appreciated that although FIG. 1 shows a wireless communication system 10 in the form of an LTE based system, the example embodiments herein may also be utilised in connection with other wireless communication systems, such as e.g. Global System for Communication (GSM) or UMTS (Universal Mobile Telecommunications System), comprising nodes and functions that correspond to the nodes and functions of the system in FIG. 1.

The wireless communication system 10 comprises one or more base stations in the form of an eNodeB 1, operatively connected to a Serving Gateway (SGW), in turn operatively connected to a Mobility Management Entity (MME) and a Packet Data Network Gateway (PGW), which in turn is operatively connected to a Policy and Charging Rules Function (PCRF). The eNodeB 1 is a radio access node that interfaces with a mobile terminal 2, providing downlink communication to the mobile terminal 2 and uplink communication from the mobile terminal 2. The term mobile terminal is also known as mobile communication terminal, user equipment (UE), wireless device, user terminal, user agent, wireless terminal, machine-to-machine device etc., and can be, for example, what today are commonly known as a mobile phone or a tablet/laptop with wireless connectivity.

The eNodeB 1 of the system forms part of the E-UTRAN (Evolved Universal Terrestrial Radio Access Network) for LTE communicating with the mobile terminal 2 over an air interface such as LTE-Uu. The core network in LTE is known as Evolved Packet Core (EPC), and the EPC together with the E-UTRAN is referred to as Evolved Packet System (EPS). The SGW routes and forwards user data packets over the S1-U interface For idle state mobile terminals, the SGW terminates the downlink data path and triggers paging when downlink data arrives for the mobile terminal 2. The SGW may also perform replication of the user traffic in case of lawful interception. The SGW communicates with the MME via interface S11 and with the PGW via the S5 interface. Further, the SGW may communicate with the UMTS radio access network UTRAN and with the GSM EDGE (“Enhanced Data rates for GSM Evolution”) Radio Access Network (GERAN) via the S12 interface via radio base stations referred to as NodeBs in UTRAN and Base Station Transceivers (BTSs).

The MME also terminates the S6a interface, towards the Home Subscriber Database (HSS). The MME communicates with the E-UTRAN via an S1-MME interface.

The PGW provides connectivity to the mobile terminal 2 to external packet data networks (PDNs) 7 by being the point of exit and entry of traffic for the mobile terminal 2. A mobile terminal 2 may have simultaneous connectivity with more than one PGW for accessing multiple PDNs. The PGW performs policy enforcement, packet filtering for each user, charging support, lawful interception and packet screening. Another role of the PGW is to act as the anchor for mobility between 3GPP and non-3GPP technologies such as Wireless Local Area Network (WLAN) and 3GPP2 (CDMA (Code Division Multiple Access) 1X and EvDO (Evolution-Data Optimised)). WLAN is also known as Wi-Fi. The interface between the PGW and the packet data network 7 is referred to as the SGi. The packet data network 7 could be any suitable packet data network, such as the Internet or alternatively an operator specific network, a private packet data network or an intra operator packet data network, e.g. for provision of IP Multimedia Subsystem (IMS) services.

The PCRF determines policy rules in real-time with respect to the mobile terminals of the system. This may e.g. include aggregating information in real-time to and from the core network and operational support systems, etc. of the system so as to support the creation of rules and/or automatically making policy decisions for user radio terminals currently active in the system based on such rules or similar. The PCRF provides such rules and/or policies or similar to be used by the acting PGW as a Policy and Charging Enforcement Function (PCEF) via interface Gx, to the SGW via interface Gxc, to a trusted WLAN 5a via interface Gxa and to an Evolved Packet Data Gateway (ePDG) via interface Gxb. When S5, S2a or S2b are based on GTP (GPRS tunnelling protocol (GTP)), the polices are sent over GTP. The PCRF further communicates with the packet data network 7 via the Rx interface.

The system further comprises a 3GPP Authentication, Authorisation and Accounting (AAA) server, which takes care of the authentication, authorisation and accounting of the mobile terminal 2 connecting to the EPC network via an untrusted WLAN 5b and ePDG across interface SWm. The ePDG further connects to the PGW via interface S2b using GTP or Proxy Mobile IPv6 (PMIP) and to the untrusted WLAN 5b via interface SWn. The 3GPP AAA server also connects to the HSS via interface SWx, to the PGW via interface S6b, to the trusted WLAN 5a via interface STa and to the untrusted WLAN 5b via interface SWa. The mobile terminal 2 can in this way connect to the trusted WLAN 5a using a trusted access point 3a, and/or the untrusted WLAN 5b using an untrusted access point 3b. The trusted access point 3a connects to the PGW via a Trusted Wireless Access Gateway (TWAG). The trusted access point 3a thus provides a gateway for the mobile terminal 2 between the EPC network and trusted WLAN and further connects to the PGW via interface S2a.

Using wireless communication system 10, two access networks 8, 9 can be used for communication between the mobile terminal 2 and the packet data network 7. A first access network is a 3GPP network 8, in this example an E-UTRAN of an LTE network. A second access network 9 is a non-3GPP network, in this example a WLAN network. The trusted access point 3a and the untrusted access point 3b are thus radio access nodes for the second (non-3GPP) access network 9.

In one embodiment, a trusted WLAN is managed by an operator (e.g. an operator hotspot) whereas the untrusted WLAN is not managed by the operator (e.g. a WiFi access point at home). The ePDG acts as a security gateway between the untrusted WLAN 5b and the core network of the operator. The mobile terminal 2 sets up a secure tunnel to the ePDG, and there is the S2b interface between the ePDG and the PGW. For the trusted WLAN 5a, there is a point-to-point interface between the mobile terminal 2 and the trusted access point 3a, and the S2a interface between TWAG (connected to the trusted access point 3a) and the PGW.

PDN connections can be setup over the 3GPP access network 8 or over the non-3GPP access network 9. A mobile terminal may have one or more PDN connections over a 3GPP access network, and/or one or more PDN connections over a non-3GPP access network.

Every PDN connection consists of one or more bearers. A bearer uniquely identifies traffic flows that receive a common QoS (Quality of Service) treatment between a mobile terminal and a PGW. Each bearer over a particular access network has a unique bearer ID. The bearer IDs assigned for a specific mobile terminal on the S2a/S2b interfaces are independent of the bearer IDs assigned for the same mobile terminal on the S5 interface and may overlap in value.

On the 3GPP access network 8, the bearer is end-to-end between the mobile terminal and the PGW. The bearer ID is known by the PGW, the MME, the eNodeB and the mobile terminal. In the prior art, on the non-3GPP access network, there is no bearer concept between the mobile terminal and TWAG 3a or the ePDG. The bearer concept is only defined between the PGW and the TWAG 3a and the ePDG; i.e. it is only defined over the S2a/S2b interfaces. In this case, the bearer ID is known by the PGW, the TWAG and ePDG but not by the mobile terminal. Regardless of access network type, the PCRF is not aware of bearer IDs. According to embodiments presented herein, end-to-end bearers are provided also over non-3GPP access networks, as described in more detail below.

Every PDN connection has at least one bearer and this bearer is called the default bearer. All additional bearers on the PDN connection are called dedicated bearers

A bearer carries traffic in the form of IP packets. IP fillers define which traffic is carried on a bearer. A filter is an IP n-tuple where each element in the tuple contains a value, a range, or a wildcard. An n-tuple is also known as an IP flow.

An example of a 5-tuple is (destination IP=83.50.20.110, source IP=145.45.68.201, destination port=80, source port=*, protocol=TCP). This 5-tuple defines a source and destination IP address, a source and destination port, and a protocol. The source port is a wildcard. Traffic matching this 5-tuple filter would be all TCP traffic from IP=145.45.68.201 to IP=83.50.20.110 and port=80.

A traffic flow template, TFT, contains one or more fillers, such as n-tuples. The TFT is one form of a routing rule. Every bearer has a TFT. One bearer within a PDN connection and access network may lack an explicit TFT (this bearer is typically the default bearer). Implicitly, such bearer has a TFT with a single filler matching all packets.

As described above, IFOM stands for IP flow mobility. An IFOM PDN connection is a special PDN connection that maintains a single IP address/prefix but can be routed over multiple access networks simultaneously. The mobile terminal and the PGW negotiate which IP flow gets routed over which access network.

Even though an IFOM PDN connection may be routed over multiple access networks simultaneously, the bearers on each access network within that PDN connection are independent of each other.

In order to negotiate which IP flow shall be routed over which access network, routing rule update procedures are defined. A routing rule update can be initiated either from the mobile terminal or from the PGW.

Within the 3GPP access network 8, a radio access network controller (RC) in the radio access network (RAN) 8 decides when the mobile terminal shall perform a handover from one eNodeB to another eNodeB. The RC may be co-located with an eNodeB, a RNC (Radio Network Controller) or a BSC (Base Station Controller). While the RC is aware of bearers, it has no knowledge of PDN connections or IP flows. The decision made in the RAN is based on multiple inputs with a goal to increase the number of satisfied users in the network. The input information can comprise any one or more of data about network topology, current radio conditions, load, mobile terminal capabilities, cell capabilities, traffic conditions and/or subscription details.

In current 3GPP access networks, it is the eNodeB (or more generally, the RAN) that decides when to move a bearer of a specific mobile terminal from a source eNodeB to a target eNodeB. However, it is not presented in the current 3GPP specification how the RAN can trigger a handover of a bearer of a specific mobile terminal from a 3GPP access network to a non-3GPP access network. Using the embodiments presented herein, described in more detail below, handover of traffic of a source bearer of a first access network to a second access network is enabled.

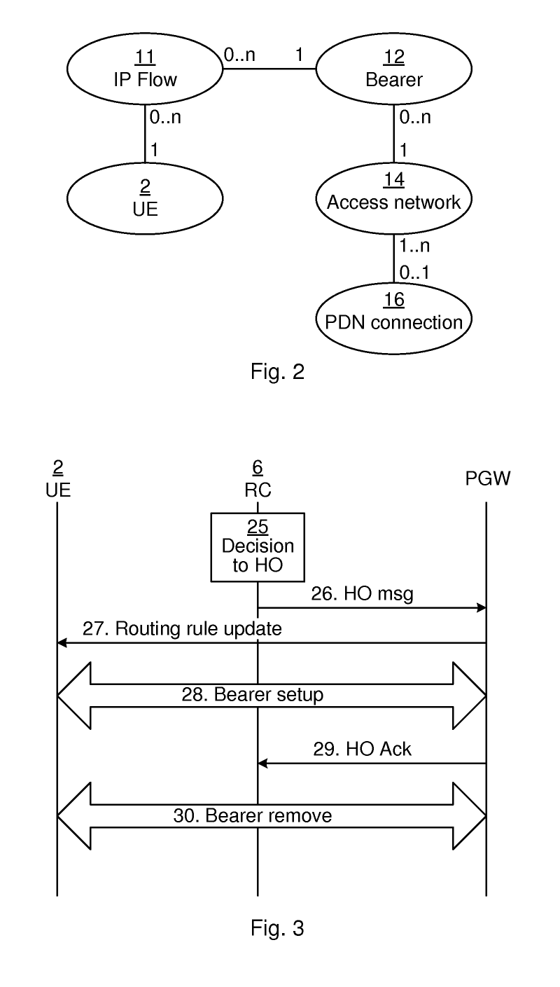

FIG. 2 is an entity relationship diagram illustrating relations for data connections in the system of FIG. 1.

A mobile terminal 2 is associated with o or more IP flows 11. Each IP flow is associated with a traffic flow template. Each IP flow 11 is associated with a data bearer 12, where a plurality of IP flows 11 can share a single data bearer 12. However, a data bearer 12 can be established without being associated with any IP flows 11.

Each data bearer 12 is associated with an access network 14, where a plurality of bearers 12 can share a single access network 14. Each access network 14 is associated with zero or more data bearers 12.

Each access network 14 is associated with zero or one PDN connection 16, where a plurality of access network can share a single PDN connection 16. Each PDN connection 16 is associated with at least one access network 14.

FIG. 3 is a sequence diagram illustrating handover of a data bearer in the wireless communication system of FIG. 1 according to one embodiment. Prior to this sequence starting, there is at least one bearer over the 3GPP network and at least one data bearer over the non-3GPP network. Moreover, the mobile terminal and the network both support IFOM.

A RAN controller 6 (RC) is aware of the bearers, and their IDs, on each access network (3GPP/non-3GPP). The RC 6 could obtain this information e.g. from the bearer setup signaling.

The sequence of FIG. 3 will be illustrated with an example where the mobile terminal has a single IFOM PDN connection with three bearers. Bearers A and B are currently routed over 3GPP and bearer C is currently routed over WLAN.

At a certain point in time, the RC 6 decides 25 upon a handover of one or more data bearers from 3GPP to non-3GPP or vice versa.

The RC 6 then sends a handover message 26 to the PGW. In the example the RC instructs the PGW to handover bearer A to non-3GPP. The handover message 26 indicates to the PGW to handover all IP flows of a bearer from one access network to another access network using network-initiated IFOM routing rule updates.

The PGW maps the bearer ID to the TFTs of the bearer and sends a routing rule update message 27 to the mobile terminal 2 based on those TFTs, i.e. a network-initiated routing rule update procedure.

If the mobile terminal 2 has acknowledged the routing rule update, the PGW sets up a new bearer 28 of the target access network. In the example, this involves establishing a new bearer over non-3GPP with the same TFT set as bearer A. Existing 3GPP procedures can be used for this step. For example, the procedure “Dedicated Bearer Activation” in TS 23.401 section 5.4.1 can be employed when the 3GPP access network is used, or a similar procedure in TS 23.402 section 16.5 when non-3GPP and S2a is used. Note that if the default bearer traffic is to be moved, or if a corresponding dedicated bearer exists on the target access network, there is no need to establish a new bearer as the default bearer is already available in the target access network.

If a new bearer is established a new ID for this bearer is allocated, in the example bearer D. The new ID can be sent back to the RC 6 as part of an acknowledgement 29. The acknowledgement 29 may also contain both the new and old IDs, i.e. an association that bearer with ID A became bearer with ID D. This may be useful in the case when multiple bearers are indicated in the handover message 26.

At this point in the example, all traffic flows of bearer A over 3GPP have been moved to bearer D over non-3GPP. Bearer A may then be torn down, or removed, 30 by the PGW. Removing bearers may not always be possible, e.g. when the bearer is the default bearer and there are no additional bearers active over that access network or there is a desire to keep the PDN Connection active over the 3GPP access network. Removing the last bearer on an access network will have the effect that the complete PDN connection over this access network is torn down. This may not always be desired.

The transmission of the handover message 26 and the handover acknowledgement 29 can be implemented in several ways. For instance, one or more of the following transmission mechanisms can be used: to/from 3GPP access network using control plane signaling, to/from 3GPP access network using user plane transmission, to/from non-3GPP access network using control plane signaling, to/from non-3GPP access network using user plane transmission and/or using off-path communication.

Optionally, the handover message 26 and the handover acknowledgement 29 could be sent over different network interfaces and different protocols. The exact signaling path also depends on where the RC 6 is located, e.g. in eNodeB, AP, standalone, or distributed between different entities. One example is to re-use existing 3GPP procedures, e.g. control plane signaling to create, modify or remove an existing bearer.

Note that the order shown is not mandated, and in particular, the routing rule update 27 and the bearer setup 28 can be swapped compared to what is shown in FIG. 3. In some cases, the routing rule update 27 and the bearer setup 28 could even be combined and performed in a single step.

The RC 6 may be co-located with the eNodeB or the AP (i.e. on one access network only). The RC may be even implemented either as a centralized RAN function connected to both access networks or as a distributed function in both the eNodeB and the access point (3a-b of FIG. 1), with communication in-between the eNodeB and the access point.

In this way, the RAN can control handover of bearers between a 3GPP access network and a non-3GPP access network, just as it today can control handover of bearers within a 3GPP access network. One benefit of having eNodeB (or RAN) level control of the handovers is that the handover decisions can be based on multiple inputs with a goal to increase the number of satisfied users in the network. The input information contains both information only available in RAN, and information available also in other places in the network. This information can for instance consist of: radio network topology information, radio link quality for the mobile terminal in the current cell and other cells as measured by the mobile terminal, cell load in the current cell for the mobile terminal and in other cells as measured by the mobile terminal, mobile terminal capabilities, cell capabilities (current cell and other cells as measured by the mobile terminal), mobile terminal activity/traffic volume and subscription based information (received from the core network).

The RAN control of handover of bearers from non-3GPP access network to 3GPP access network may be implemented based on the acknowledgement 29 containing the new ID, i.e. the association that bearer with ID A in the 3GPP-access network became bearer with ID D in non-3GPP access network. When the RC 6 receives the acknowledgement 29 it can store the new ID, ID D, and use it for later control of handover of bearers from non-3GPP access network to 3GPP access network. In the example, the RC can then instruct the PGW to handover bearer D to 3GPP access network using a new handover message. The handover message 26 then indicates to the PGW to handover all IP flows of bearer with ID D from non-3GPP access network to 3GPP access network using network-initiated IFOM routing rule updates. The other actions are similar to what is described above, with reference to FIG. 3.

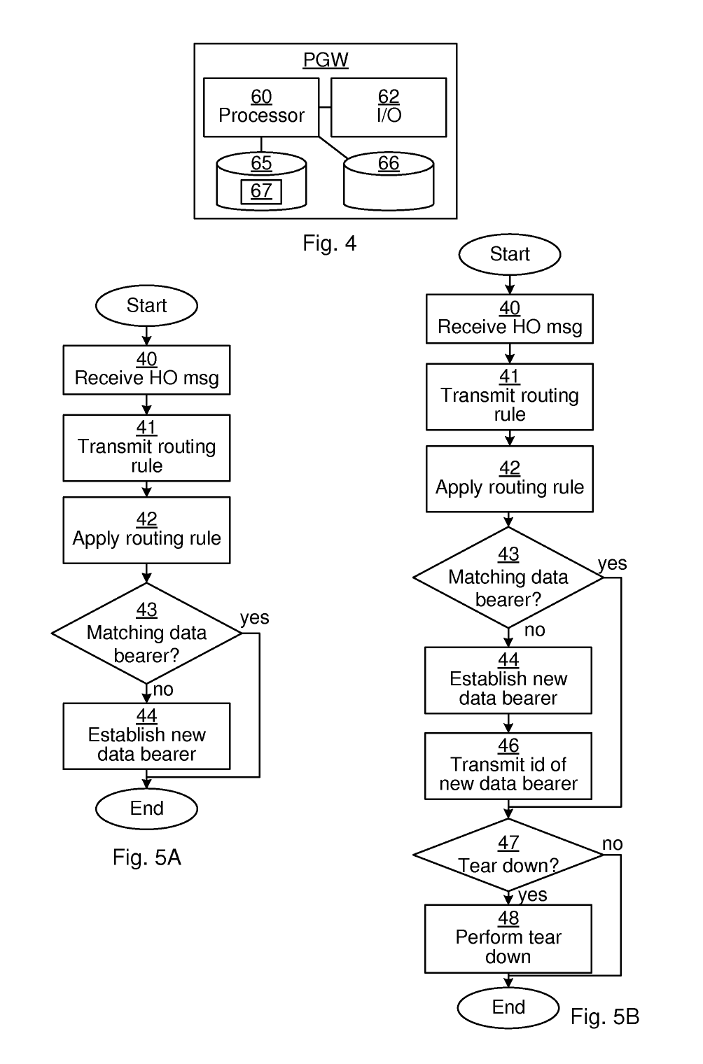

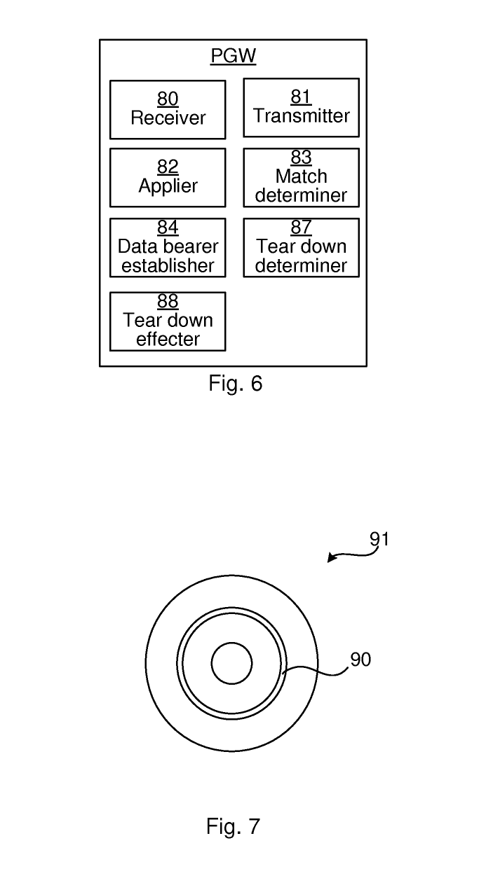

FIG. 4 is a schematic diagram showing some components of the PGW of FIG. 1 according to one embodiment. A processor 60 is provided using any combination of one or more of a suitable central processing unit (CPU), multiprocessor, microcontroller, digital signal processor (DSP), application specific integrated circuit etc., capable of executing software instructions 67 stored in a memory 65, which can thus be a computer program product. The processor 6o can be configured to execute the method described with reference to FIGS. 5A-B below.

The memory 65 can be any combination of read and write memory (RAM) and read only memory (ROM). The memory 65 also comprises persistent storage, which, for example, can be any single one or combination of magnetic memory, optical memory, solid state memory or even remotely mounted memory.

A data memory 66 is also provided for reading and/or storing data during execution of software instructions in the processor 60. The data memory 66 can be any combination of read and write memory (RAM) and read only memory (ROM).

The PGW further comprises an I/O interface 62 for communicating with other external entities. Optionally, the I/O interface 62 also includes a user interface.

FIGS. 5A-B are flow charts illustrating embodiments of methods performed in the PGW of FIG. 1 for handing over a data bearer for traffic of an IFOM packet data connection. The IFOM packet data connection is between a packet data network and a mobile terminal. The handover occurs from one access network to another access network.

In a receive HO msg (message) step 40, a handover message (26 of FIG. 3) is received from an RC. The handover message comprises a request to handover a source data bearer for the mobile terminal from a first access network to a second access network. In line with what is described above, the first access network is a 3GPP network and the second access network is a non-3GPP network, or vice versa. The non-3GPP network can e.g. be a WLAN as described above.

In a transmit routing rule step 41, a first routing rule is transmitted to the mobile terminal, e.g. as a routing rule update (27 of FIG. 3). The first routing rule mapping all (uplink) traffic flows of the source data bearer to the second access network. The first routing rule can e.g. be defined using a traffic flow template as described above. In this way, the mobile terminal is requested to use the first routing rule for uplink traffic. Consequently, uplink traffic flows which previously were routed over the source data bearer (on the first access network) are then routed over the second access network. A matching data bearer is established later, so a default data bearer of the second access network may be used in the meantime.

In an apply routing rule step 42, the first routing rule is applied for downlink traffic. In one embodiment, this step is only performed after receiving an acknowledgement from the mobile terminal that it will apply the first routing rule. The mobile terminal could reject the first routing rule for uplink traffic, and in such a case, there is no need to apply the second routing rule for downlink traffic.

In a conditional matching data bearer step 43, the PGW determines when there is no matching data bearer over the second access network to the mobile terminal, which matching data bearer matches the first routing rule.

In one embodiment, the PGW determines a match to occur only when a current routing rule of a data bearer of the second access network comprises IP fillers and a quality of service profile which matches the first routing rule. In one embodiment, the filters of the current routing rule need to be identical to the fillers of the first routing rule to match.

If there is no matching data bearer, the method proceeds to an establish new data bearer step 44. Otherwise, the method ends.

In the establish new data bearer step 44, a new data bearer is established over the second access network (28 of FIG. 3). The new data bearer has a second routing rule which matches the first routing rule. The second routing rule can e.g. be defined using a traffic flow template as described above.

Looking now to FIG. 5B, only new or modified steps compared to the method illustrated by the flow chart of FIG. 5A will be described.

In a transmit id of new data bearer step 46, when a new data bearer is established, an identifier of the new data bearer is transmitted to the radio access network controller, e.g. as part of a handover acknowledgement (29 of FIG. 3). Optionally, this step also comprises transmitting an identifier of the source data bearer.

In a conditional tear down step 47, the PGW determines whether to tear down the source data bearer. If this is the case, the method proceeds to a perform tear down step 48. Otherwise, the method ends.

In one embodiment, this step comprises determining not to tear down the source data bearer when the source data bearer is a default bearer for the first access network. In this way, the default bearer is kept set up even when handover of traffic for the default bearer is moved to another access network.

In the perform teardown step 48, the source data bearer is torn down (30 of FIG. 3).

FIG. 6 is a schematic diagram showing functional modules of the PGW of FIG. 4 according to one embodiment. The modules are implemented using software instructions such as a computer program executing in the PGW. The modules correspond to the steps in the methods illustrated in FIGS. 5A-B.

A receiver 80 is configured to receive a handover message from a radio access network controller. This module corresponds to the receive HO msg step 40 of FIGS. 5A-B.

A transmitter 81 is configured to transmit a first routing rule to the mobile terminal, the first routing rule mapping all traffic flows of the source data bearer to the second access network. The transmitter 81 can also be configured to transmit, when a new data bearer is established, an identifier of the new data bearer to the radio access network controller. This module corresponds to the transmit routing rule step 41 of FIGS. 5A-B and the transmit id of new data bearer step 46 of FIG. 5B.

An applier 82 is configured to apply the first routing rule for downlink traffic. This module corresponds to the apply routing rule step 42 of FIGS. 5A-B.

A match determiner 83 is configured to determine when there is no matching data bearer over the second access network to the mobile terminal, matching the first routing rule. This module corresponds to the conditional matching data bearer step 43 of FIGS. 5A-B.

A data bearer establisher 84 is configured to establish, when there is no matching data bearer, a new data bearer over the second access network. This module corresponds to the establish new data bearer step 44 of FIGS. 5A-B.

A tear down determiner 87 is configured to determine whether to tear down the source data bearer. This module corresponds to the conditional tear down step 47 of FIG. 5B.

A tear down effecter 88 is configured to tear down the source data bearer. This module corresponds to the perform tear down step 48 of FIG. 5B.

FIG. 9 shows one example of a computer program product comprising computer readable means. On this computer readable means a computer program 91 can be stored, which computer program can cause a processor to execute a method according to embodiments described herein. In this example, the computer program product is an optical disc, such as a CD (compact disc) or a DVD (digital versatile disc) or a Blu-Ray disc. As explained above, the computer program product could also be embodied in a memory of a device, such as the computer program product 65 of FIG. 3 or 75 of FIG. 4. While the computer program 91 is here schematically shown as a track on the depicted optical disk, the computer program can be stored in any way which is suitable for the computer program product, such as a removable solid state memory, e.g. a Universal Serial Bus (USB) drive.

The invention has mainly been described above with reference to a few embodiments. However, as is readily appreciated by a person skilled in the art, other embodiments than the ones disclosed above are equally possible within the scope of the invention, as defined by the appended patent claims.

1-21. (canceled)

22. A method for handing over a data bearer for traffic of an IP Flow Mobility, IFOM, packet data connection between a packet data network and a mobile terminal from one access network to another access network, the method being performed in a packet data network gateway, PGW, and comprising:
receiving a handover message from a radio access network controller, the handover message comprising a request to handover a source data bearer for the mobile terminal from a first access network to a second access network, wherein the first access network is a Third Generation Partnership Program, 3GPP, network and the second access network is a non-3GPP network, or vice versa;
transmitting a first routing rule to the mobile terminal, the first routing rule mapping all traffic flows of the source data bearer to the second access network;
applying the first routing rule for downlink traffic;
determining whether there is no data bearer over the second access network to the mobile terminal that matches the first routing rule; and
establishing, when there is no matching data bearer, a new data bearer over the second access network, the new data bearer having a second routing rule matching the first routing rule.

23. The method according to claim 22, further comprising:
transmitting, when a new data bearer is established, an identifier of the new data bearer to the radio access network controller.

24. The method according to claim 23, wherein the transmitting the identifier comprises transmitting an identifier of the source data bearer.

25. The method according to claim 22, further comprising:
determining whether to tear down the source data bearer; and
tearing down the source data bearer responsive to a determination to tear down the source data bearer.

26. The method according to claim 25, wherein the determining whether to tear down the source data bearer comprises determining not to tear down the source data bearer when the source data bearer is a default bearer for the first access network.

27. The method according to claim 22, wherein the non-3GPP network is a wireless local area network.

28. The method according to claim 22, wherein the first routing rule and the second routing rule are each defined using a traffic flow template.

29. The method according to claim 22, wherein the step of applying the first routing rule is only performed after receiving an acknowledgement from the mobile terminal that the mobile terminal will apply the first routing rule.

30. The method according to claim 22, wherein the determining whether there is no data bearer that matches the first routing rule comprises determining a match only when a current routing rule of a data bearer of the second access network comprises IP filters and a quality of service profile that match the first routing rule.

31. A packet data network gateway, PGW, arranged to hand over a data bearer for traffic of an IP Flow Mobility, IFOM, packet data connection between a packet data network and a mobile terminal from one access network to another access network, the PGW comprising:
a processor; and
a memory storing instructions that, when executed by the processor, cause the PGW to:
receive a handover message from a radio access network controller, the handover message comprising a request to handover a source data bearer for the mobile terminal from a first access network to a second access network, wherein the first access network is a Third Generation Partnership Program, 3GPP, network and the second access network is a non-3GPP network, or vice versa;
transmit a first routing rule to the mobile terminal, the first routing rule mapping all traffic flows of the source data bearer to the second access network;
apply the first routing rule for downlink traffic;
determine whether there is no data bearer over the second access network to the mobile terminal that matches the first routing rule; and
establish, when there is no matching data bearer, a new data bearer over the second access network, the new data bearer having a second routing rule matching the first routing rule.

32. The PGW according to claim 31, wherein the instructions further comprise instructions that, when executed by the processor, cause the PGW to transmit, when a new data bearer is established, an identifier of the new data bearer to the radio access network controller.

33. The PGW according to claim 32, wherein the instructions to transmit the identifier also comprise instructions that, when executed by the processor, cause the PGW to transmit an identifier of the source data bearer.

34. The PGW according to claim 31, wherein the instructions further comprise instructions that, when executed by the processor, cause the PGW to:
determine whether to tear down the source data bearer; and
tear down the source data bearer responsive to a determination to tear down the source data bearer.

35. The PGW according to claim 34, wherein the instructions to determine whether there is no data bearer over the second access network that matches the first routing rule comprise instructions that, when executed by the processor, cause the PGW to determine not to tear down the source data bearer when the source data bearer is a default bearer for the first access network.

36. The PGW according to claim 31, wherein the non-3GPP network is a wireless local area network.

37. The PGW according to claim 31, wherein the first routing rule and the second routing rule are each defined using a traffic flow template.

38. The PGW according to claim 31, wherein the instructions further comprise instructions that, when executed by the processor, cause the PGW to apply the first routing rule only after receiving an acknowledgement from the mobile terminal that the mobile terminal will apply the first routing rule.

39. The PGW according to claim 31, wherein the instructions to determine whether there is no data bearer over the second access network that matches the first routing rule comprise instructions that, when executed by the processor, causes the PGW to determine a match only when a current routing rule of a data bearer of the second access network comprises IP filters and a quality of service profile that match the first routing rule.

40. A non-transitory computer-readable storage medium storing a computer program for handing over a data bearer for traffic of an IP Flow Mobility, IFOM, packet data connection between a packet data network and a mobile terminal from one access network to another access network, the computer program comprising computer program instructions which, when executed on a processor of a packet data network gateway, PGW, causes the PGW to:
receive a handover message from a radio access network controller, the handover message comprising a request to handover a source data bearer for the mobile terminal from a first access network to a second access network, wherein the first access network is a Third Generation Partnership Program, 3GPP, network and the second access network is a non-3GPP network, or vice versa;
transmit a first routing rule to the mobile terminal, the first routing rule mapping all traffic flows of the source data bearer to the second access network;
apply the first routing rule for downlink traffic;
determine whether there is no data bearer over the second access network to the mobile terminal that matches the first routing rule; and
establish, when there is no matching data bearer, a new data bearer over the second access network, the new data bearer having a second routing rule matching the first routing rule.
